(19) United States
(12) Patent Application Publication
(10) Pub. No.: US 2026/0303388 A1
(43) Pub. Date: Oct. 1, 2026

(54) PROGRAMMING MULTICAST FORWARDING ENTRIES IN AN OVERLAY NETWORK

(71) Applicant: HEWLETT PACKARD ENTERPRISE DEVELOPMENT LP, Spring, TX (US)

(72) Inventors: Tathagata Nandy, Bangalore (IN); Chethan Chavadibagilu Radhakrishnabhat, Bangalore (IN); Pramod Kumar A. S., Bangalore (IN); Anil Raj, Bangalore (IN); Somnath Bhimaram Lohar, Bangalore (IN)

(21) Appl. No.: 19/213,757

(22) Filed: May 20, 2025

(30) Foreign Application Priority Data
Mar. 31, 2025 (IN) 202541031632

(51) Int. Cl. H04L 12/18; H04L 12/46; H04L 45/16; H04L 45/64

(52) U.S. Cl. CPC H04L 12/18; H04L 12/4633; H04L 45/16; H04L 45/64

(57) ABSTRACT

A first network device in an overlay network can receive a notification message indicating that a host reachable via a second network device joined a multicast group. The notification message can be received via a first tunnel between the first and second network devices in the first overlay network. The first network device can determine whether it is a distributor of multicast traffic in the first overlay network. If the first network device is the distributor, the first network device can program the forwarding hardware of the first network device with a first multicast forwarding entry for the multicast group based on the notification message. The first network device can then receive the multicast traffic of the multicast group over a second tunnel from a third network device and forward the multicast traffic over the first tunnel to the second network device based on the first multicast forwarding entry.

### BACKGROUND

A network device, such as a switch, may support diverse protocols and services. For example, the network device can support an overlay network constructed using tunneling and virtual private networks (VPNs). The network device can then facilitate overlay routing for VPN traffic across these tunnels.

### BRIEF DESCRIPTION OF THE FIGURES

FIG. 1 illustrates an example of an overlay network distributing multicast traffic based on a multicast distributor selected for programming multicast entries, in accordance with an aspect of the present application.

FIG. 2 illustrates an example of a plurality of overlay networks distributing multicast traffic based on respective multicast distributors selected for programming multicast entries, in accordance with an aspect of the present application.

FIG. 3 presents a flowchart illustrating an example of a process of a network device forwarding multicast traffic in an overlay network, in accordance with an aspect of the present application.

FIG. 4A presents a flowchart illustrating an example of a process of a network device forwarding multicast traffic received from a source to the multicast distributor in an overlay network, in accordance with an aspect of the present application.

FIG. 4B presents a flowchart illustrating an example of a process of a network device forwarding multicast traffic received from a source to a host coupled to the network device, in accordance with an aspect of the present application.

FIG. 5 presents a flowchart illustrating an example of a process of a network device receiving and forwarding multicast traffic in an overlay network based on respective encapsulation headers, in accordance with an aspect of the present application.

FIG. 6 illustrates an example of a computing system programming multicast forwarding entries and forwarding multicast traffic in an overlay network, in accordance with an aspect of the present application.

FIG. 7 illustrates an example of a computer-readable medium (CRM) facilitating the programming of multicast forwarding entries and forwarding of multicast traffic in an overlay network, in accordance with an aspect of the present application.

In the figures, like reference numerals refer to the same figure elements.

### DETAILED DESCRIPTION

Multicast technology is essential for many Internet applications, enabling efficient content distribution from a single source to multiple hosts via network devices such as switches and routers. This approach can optimize bandwidth usage and reduces redundant traffic. Network-layer multicast protocols can be employed to facilitate multicast across a network. Protocol-Independent Multicast (PIM) is a common protocol used to construct and maintain multicast distribution trees, ensuring efficient content delivery to all intended recipients.

Hosts wishing to receive traffic from a specific multicast group can initiate the process by sending a client join request to an upstream network device. This join request can be an Internet Group Management Protocol (IGMP) request in Internet Protocol version 4 (IPv4) networks or a Multicast Listener Discovery (MLD) request in IP version 6 (IPv6) networks. The network device receiving this join request can be referred to as the requesting network device. In an overlay network, the requesting network device can send a notification message indicating that a host has requested to join the multicast group to all other network devices. Upon receiving this request, a network device can program a multicast forwarding entry in its forwarding hardware (such as the content-addressable-memory, CAM, used for storing forwarding entries). Based on this entry, the network device can forward multicast traffic to the requesting network device over a corresponding tunnel. However, programming forwarding entries for a large number of multicast groups can strain the hardware resources of the network device.

The aspects described herein address the problem of optimizing hardware resource utilization associated with programming multicast entries in an overlay network device by (i) designating a network device within the overlay network to program the multicast entries; and (ii) forwarding multicast traffic from all other devices to this designated network device. This designated network device, referred to as a distributor device (or simply distributor), programs the multicast entries in its forwarding hardware, allowing for effective distribution of multicast traffic. When a non-distributor network device within the overlay network receives multicast traffic, it forwards this multicast traffic to the distributor, which then sends the multicast traffic to the appropriate hosts. This centralized approach streamlines the management and distribution of multicast traffic across the overlay network.

In general, overlay networks are constructed using overlay routing for VPNs across a set of tunnels, often referred to as a distributed tunnel fabric. For example, an Ethernet VPN (EVPN) can be deployed as an overlay across Virtual Extensible Local Area Networks (VXLANs). Communication between network devices within the overlay network can occur via a tunnel. To deploy a VPN over the tunnels, each tunnel endpoint maps a respective client virtual local area network (VLAN) to a corresponding tunnel network identifier (TNI), which can identify a virtual network for a tunnel. The TNI appears in a tunnel header that encapsulates a packet and is used to forward the encapsulated packet via the tunnel. If the tunnel is based on VXLAN, the TNI can be a virtual network identifier (VNI) of a VXLAN header, and a tunnel endpoint can be a VXLAN tunnel endpoint (VTEP).

Among the network devices of the overlay network, a border network device (or border device) can facilitate communication outside the overlay network by handling traffic to and from the overlay network. The overlay network may support a multicast protocol for distributing multicast traffic, such as Protocol Independent Multicast sparse-mode (PIM-SM), bidirectional PIM (PIM-BIDIR), Distance Vector Multicast Routing Protocol (DVMRP), Core Based Trees (CBT), or Source-Specific Multicast (SSM). During operation, a network device coupling a source of a multicast group can receive multicast traffic for that group. This network device, referred to as a source network device, functions as the source-connected designated router (DR) or source DR, and is responsible for forwarding multicast traffic to requesting network devices. Conversely, a requesting network device can operate as the client-connected DR or client DR, and is responsible for requesting multicast traffic for a specific multicast group.

To forward multicast traffic efficiently in an overlay network, upon receiving a client join request (e.g., an IGMP join) for a multicast group, the requesting network device (the first-hop device coupled to the host requesting the multicast content) can send a notification message to all other network devices in the overlay network via corresponding tunnels. The notification message indicates that the requesting network device has received a request to receive multicast traffic of the multicast group, and that a host reachable via the requesting network device has requested to join the multicast group. If the overlay network is an EVPN fabric, the notification message can be an EVPN type-6 route update message.

When other network devices in the overlay network receive the notification message, they can program a multicast forwarding entry (or a multicast entry) for the multicast group in their respective forwarding hardware. The multicast entry can indicate where to forward multicast traffic for that specific multicast group. Consequently, the source network device can send the multicast traffic to the requesting network device instead of forwarding it to all other network devices in the overlay network. Typically, multicast traffic comprises multiple packets destined for a multicast address (e.g., the multicast IP address) of the respective multicast group. This structure facilitates efficient distribution of multicast content across the overlay network while maintaining connectivity with external networks.

A large network may include multiple overlay networks, each based on a distinct tunnel fabric. These overlay networks can be interconnected through dedicated border devices, potentially separated by a wide-area network (WAN) such as the Internet. To facilitate packet forwarding between two overlay networks, the border devices can establish and maintain tunnels and operate as peers. When a packet is to be forwarded to another overlay network, the border device of the originating fabric can encapsulate the packet with an additional encapsulation header and forward the encapsulated packet through the established tunnel.

To facilitate multicast traffic forwarding between overlay networks, border devices play a crucial role in disseminating information. When a border device receives a notification message associated with a host and a multicast group, it can forward the notification message to its peer border devices. The receiving border device then distributes the notification message within its own overlay network. To deliver multicast traffic to the host via peer border devices, the border device in the receiving overlay network can program corresponding multicast entries in its forwarding hardware. However, this approach of programming multicast entries based on notifications from multiple overlay networks involves programming a large number of multicast entries across all network devices in the overlay network. Because forwarding hardware resources such as CAM are costly and scarce, programming these multicast entries can potentially strain such resources in the network device, presenting a scalability challenge.

To address this resource strain issue, a single network device in each overlay network can be designated as the distributor and tasked with programming its forwarding hardware to manage multicast traffic distribution within that network. The border device, typically equipped with substantial hardware resources, is often capable of maintaining a large number of multicast entries in its forwarding hardware, making it a prime candidate for the distributor role. However, any network device with the capacity to support numerous multicast entries can potentially serve as the distributor. All other non-distributor network devices can forward multicast traffic to the distributor for distribution, thus obviating the need to program a large number of multicast entries and reducing the usage of their hardware resources. In practice, when a requesting network device receives a client join request (e.g., an IGMP join) for a multicast group from a host, the requesting network device can send to the distributor a notification message associated with the host and multicast group to initiate the distribution process.

The distributor in the overlay network receives the notification message via a tunnel established between itself and the requesting network device. Upon receipt, the distributor can then program its forwarding hardware with a group-specific multicast entry, indicating that multicast traffic of the multicast group is to be forwarded over the corresponding tunnel. Non-distributor network devices in the overlay network can be preprogrammed with a generic multicast entry pointing to the distributor. This generic multicast entry specifies that multicast traffic of any multicast group is to be forwarded to the distributor. Consequently, these network devices can discard incoming notification messages, eliminating the need to program their forwarding hardware with individual entries. In a scenario where a network device is directly coupled to the multicast source, the network device can assume the role of the source network device. Based on the generic multicast entry, the source network device can forward the multicast traffic to the distributor via a tunnel between them.

Upon receiving the multicast traffic, the distributor forwards the traffic through the tunnel indicated in the group-specific entry in its forwarding hardware. Typically, the source network device sends the multicast traffic to each network device that has sent the notification message (i.e., has requested multicast traffic) over corresponding tunnels. To prevent traffic duplication, the split-horizon rule prevents the redistribution of multicast traffic received from one tunnel to another within the same overlay network. Therefore, a packet received from a tunnel within the overlay network would not normally be forwarded via another tunnel within the same overlay network. To enable the distributor to distribute multicast traffic within the overlay network, the split-horizon rule can be disabled for the distributor. Consequently, the distributor can forward the multicast traffic via the tunnel indicated in the group-specific multicast entry. This approach enables efficient programming of multicast entries in the overlay network, leveraging the hardware resources of the preselected distributor while non-distributor network devices maintain only the generic multicast entry in their forwarding hardware.

Moreover, in a distributed overlay topology, multiple overlay networks can interconnect with each other through their respective border devices. When a border device in one overlay network receives a notification message, the border device can propagate the notification message to other connected overlay networks. This cascading effect ensures that the notification message can reach all relevant networks in the topology. If the border device in a receiving overlay network serves as that network's distributor, the border device can generate a corresponding multicast entry in its forwarding hardware. This multicast entry specifies that the multicast traffic for the particular group is to be forwarded to the overlay network that originated the notification message, effectively directing traffic toward the corresponding border device. Consequently, if the multicast source resides in a different overlay network, the border device of that network can receive multicast traffic from the source network device and forward it to the overlay network that initiated the notification. This mechanism enables seamless multicast traffic distribution across interconnected overlay networks, optimizing resource utilization and ensuring efficient delivery of multicast content throughout the distributed topology.

In this disclosure, the term “switch” is used in a generic sense, and it can refer to any standalone network device or fabric switch operating in any network layer. “Switch” should not be interpreted as limiting examples of the present disclosure to layer-2 networks. Any device that can forward traffic to another device can be referred to as a “switch.” Furthermore, if the switch facilitates communication between networks, the switch can be referred to as a gateway switch. Any physical or virtual device (e.g., a virtual machine or switch operating on a computing device) that can operate as a network device and forward traffic to an end device can be referred to as a “switch.” If the switch is a virtual device, the switch can be referred to as a virtual switch. Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present disclosure to a particular layer of a network protocol stack. “Packet” can be replaced by other terminologies referring to a group of bits, such as “message,” “frame,” “cell,” “datagram,” or “transaction.” Furthermore, the term “port” can refer to an endpoint of a link that can receive or transmit data. “Port” can also refer to the hardware, software, and/or firmware logic that can facilitate the operations of that port.

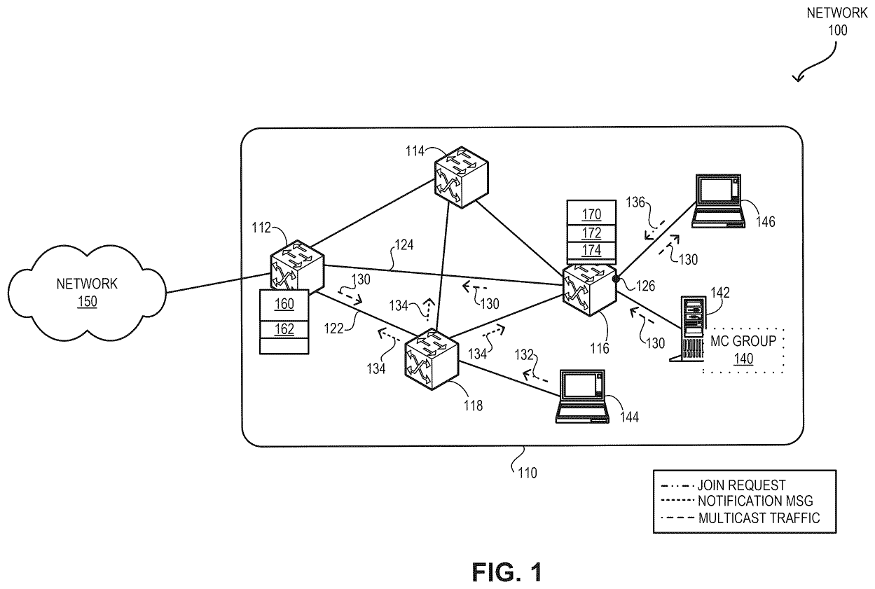

FIG. 1 illustrates an example of an overlay network distributing multicast traffic based on a multicast distributor selected for programming multicast entries, in accordance with an aspect of the present application. A network 100 can include various network devices, such as switches, and can consist of heterogeneous network connections, such as layer-2 and layer-3 hops and tunnels. In some examples, network 100 can be an Ethernet network, an InfiniBand network, or another type of network, utilizing corresponding communication protocols such as IP, Fibre Channel over Ethernet (FCoE), or others. Network 100 comprises several network devices, including network devices 112, 114, 116, and 118. User devices 142 and 146 can be coupled to network device 116, and user device 144 can be coupled to network device 118. In this scenario, user device 142 serves as the source for multicast group 140 and is thus referred to as source 142. Meanwhile, user devices 144 and 146 request multicast traffic from multicast group 140 and are therefore referred to as hosts 144 and 146, respectively.

Each network device in network 100 is assigned a unique MAC address and IP address, and is equipped with at least one processing resource. These processing resources may include, but are not limited to, processor cores, graphics processing units (GPUs), and tensor processing units (TPUs). The network device can also include at least one non-transitory computer-readable medium storing instructions that, when executed by the processing resource, causes the processing resource to perform one or more operations. Additionally, the network device incorporates forwarding hardware, such as an application-specific integrated circuit (ASIC), which typically includes a Ternary content-addressable memory (TCAM). This hardware configuration allows the network device to efficiently manage and route network traffic.

Network devices 112, 114, 116, and 118 can be part of overlay network 110, which functions as a tunnel fabric. These network devices can be interconnected via tunnels, with tunnel encapsulation initiated and terminated within the overlay network. In this example, user devices 142, 144, and 146 are coupled to and communicate via network devices of overlay network 110. In general, when a user device is coupled to an overlay network, the user device becomes part of the overlay network. The network devices in overlay network 100 may form a mesh of tunnels, which can include various types such as VXLAN, Generic Routing Encapsulation (GRE), Network Virtualization using GRE (NVGRE), Generic Networking Virtualization Encapsulation (Geneve), Internet Protocol Security (IPsec), and Multiprotocol Label Switching (MPLS). A Virtual Private Network (VPN), such as an Ethernet VPN (EVPN), can be deployed over overlay network 100. To send a packet over a tunnel, a network device acting as one endpoint encapsulates the packet with a tunnel-specific encapsulation header before forwarding it. The receiving network device, functioning as the other endpoint, then decapsulates the encapsulation header to retrieve the original packet. This encapsulation and decapsulation process enables data transmission across the overlay network.

The tunnels in overlay network 110 are established over an underlay network, which is a physical network with physical links. Each network device in overlay network 110 is also part of the underlay network, and network devices operating as tunnel endpoints function in both networks simultaneously. In the underlay network, pairs of network devices can form Border Gateway Protocol (BGP) peer relationships. This allows each network device to use BGP to establish routes for packet forwarding in the underlay network. Consequently, the encapsulated packets from overlay network 110 are forwarded through these established routes in the underlay network.

Network device 112 serves as the border device for overlay network 110, facilitating communication beyond overlay network 100′s boundaries. As a result, all traffic entering or leaving overlay network 110 is processed and forwarded by network device 112. To efficiently forward multicast traffic in overlay network 110, network devices within this network utilize notification messages to inform each other about client join requests. For instance, when network device 118 receives a join request 132 (such as an IGMP join) from host 144 for multicast group 140, network device 118 sends a notification message 134 to network devices 112, 114, and 116 through their respective tunnels. This notification message 134 indicates that network device 118 has received a request to receive multicast traffic 130 of multicast group 140, effectively communicating that host 144, accessible via network device 118, has requested this multicast traffic. In scenarios where overlay network 110 is an EVPN fabric, notification message 134 may take the form of an EVPN type-6 route update message.

Upon receiving notification message 134, network devices 112, 114, and 116 can program a multicast entry for multicast group 140 in their respective forwarding hardware's TCAM. This entry specifies that multicast traffic 130 should be forwarded to network device 118. When source 142 initiates multicast traffic 130, network device 112 receives it and identifies the multicast IP address of group 140 as the destination address. Network device 112 then looks up this address in the TCAM, identifies the corresponding multicast entry, and forwards the traffic to network device 118, rather than broadcasting it to all devices in overlay network 110. However, programming multicast entries for numerous groups can strain the limited hardware resources of the network devices in overlay network 110.

To address this issue, network device 112, serving as the border device of overlay network 110, can be designated as the distributor. Note that a border device, such as a border gateway router, is responsible for forwarding traffic destined outside of overlay network 110 and is typically equipped with more hardware resources (e.g., a larger TCAM) compared with non-border network devices. As a result, border device 112 is capable of maintaining a greater number of multicast entries in its forwarding hardware 160, making border device 112 a prime candidate for the distributor role. Because the programming of multicast entries is offloaded to border device 112, the forwarding hardware resources in the non-distributor network devices, which are relieved from storing those multicast entries, are now available for handling more traffic, thus making overlay network 110 more scalable. In general, any device capable of supporting a high volume of multicast entries in its forwarding hardware can potentially serve as the distributor. When network device 118 transmits notification message 134, network device 112 receives notification message 134 via tunnel 122. In accordance with its role as the distributor of multicast traffic in the network, network device 112 programs its forwarding hardware 160 with a group-specific multicast entry 162. This entry specifies that multicast traffic 130 for multicast group 140 should be forwarded through tunnel 122.

Before receiving any notification messages, non-distributor network devices 114, 116, and 118 can be preconfigured with a generic multicast entry that directs multicast traffic to network device 112. This generic entry can be a (*, *) entry where both source and multicast group are represented by a “wildcard” or “any” indicator “*”, and specifies that multicast traffic for any multicast group should be forwarded to network device 112. For instance, generic multicast entry 172 can be preprogrammed in the forwarding hardware 170 of network device 116, indicating that multicast traffic for any multicast group should be sent via tunnel 124 to network device 112. Since network devices 114 and 116 are not designated as distributors of multicast traffic in overlay network 110, they discard notification message 134 rather than programming their forwarding hardware. When network device 116 receives multicast traffic 130 from source 142, its forwarding hardware 170 matches multicast traffic 130 with entry 172 and forwards multicast traffic 130 to network device 112 through tunnel 124. Typically, multicast traffic 130 consists of multiple packets destined for the multicast IP address of group 140. Forwarding this traffic over tunnel 124 involves encapsulating each packet with an encapsulation header associated with the tunnel and transmitting the encapsulated packets to network device 112.

When network device 112 receives multicast traffic 130 via tunnel 124, network device 112 forwards multicast traffic 130 through tunnel 122 as specified by entry 162 in its forwarding hardware 160. This process involves decapsulating the encapsulation header associated with tunnel 124 to extract multicast traffic 130, then re-encapsulating it with another encapsulation header for tunnel 122. Typically, the split-horizon rule prevents redistribution of multicast traffic 130 from tunnel 124 to tunnel 122 within the same overlay network 110. However, to enable network device 112 to distribute multicast traffic 130 within overlay network 110, the split-horizon rule can be disabled for this device. As a result, network device 112 can forward multicast traffic 130 through tunnel 122 based on entry 162.

In this example, host 146 can be connected to port 126 of network device 116. When host 146 sends a client join request 136 (such as an IGMP join) for multicast group 140, network device 116 receives it and determines that source 142 is directly connected to itself via port 126. In this case, network device 116 refrains from sending a notification message to other devices in overlay network 110. Instead, network device 116 programs its forwarding hardware 170 with a group-specific multicast entry 174, indicating that multicast traffic 130 for group 140 should be forwarded to port 126. When network device 116 receives multicast traffic 130 from source 142, network device 116 forwards multicast traffic 130 to port 126 based on entry 174. Thus, network device 116, acting as the source network device for multicast group 140, bypasses the distributor (network device 112) and forwards multicast traffic 130 directly to the locally couped host 146.

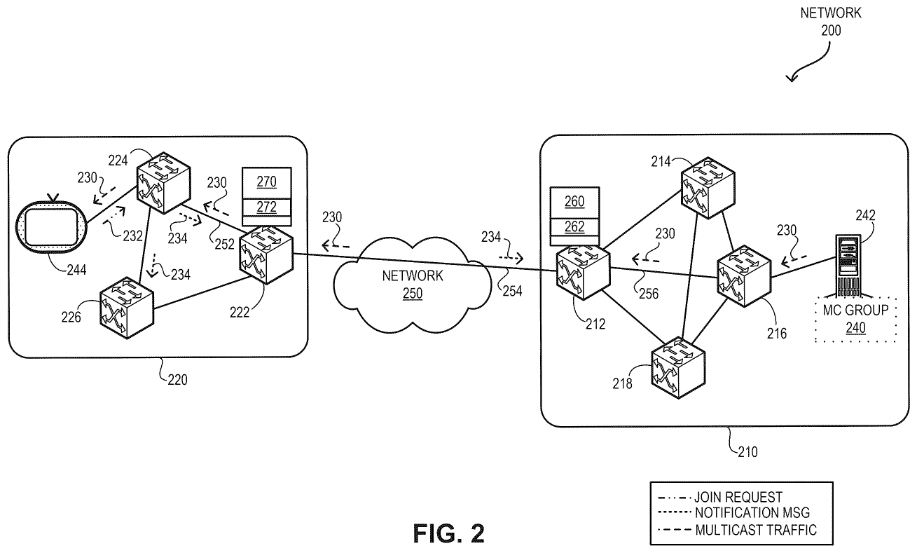

FIG. 2 illustrates an example of a plurality of overlay networks distributing multicast traffic based on respective multicast distributors selected for programming multicast entries, in accordance with an aspect of the present application. A network 200 comprises a variety of network devices, such as switches, and may incorporate heterogeneous connections including layer-2 and layer-3 hops, as well as tunnels. This network can be implemented as an Ethernet, InfiniBand, or other type of network, utilizing protocols like IP, FCoE, or others as appropriate. Network 200 can be a distributed overlay network, encompassing multiple overlay networks, such as overlay networks 210 and 220. Overlay network 210 operates as a tunnel fabric comprising network devices 212, 214, 216, and 218 interconnected through tunnels. Similarly, overlay network 220 operates as another tunnel fabric, comprising network devices 222, 224, 226, and 228 interconnected through tunnels.

Network devices in each of overlay networks 210 and 220 may form a mesh of tunnels. Examples of a tunnel can include, but are not limited to, VXLAN, GRE, NVGRE, Geneve, IPsec, and MPLS. A VPN, such as an EVPN, can be deployed over overlay networks 210 and 220. A respective network device in network 200 can be assigned a MAC address and an IP address and can include at least one processing resource. Examples of a processing resource can include, but are not limited to, a processor core, a GPU, and a TPU. The network device can also include at least one non-transitory computer-readable medium storing instructions that, when executed by the processing resource, causes the processing resource to perform one or more operations. The network device can further include forwarding hardware (e.g., the ASIC of the network device, which can at least incorporate a TCAM).

Overlay networks 210 and 220 are interconnected via their respective border devices 212 and 222. These overlay networks are separated by network 250, which may be a WAN such as the Internet. To facilitate packet forwarding between the overlay networks, border devices 212 and 222 maintain tunnel 254 through network 250. User devices 242 and 244 are coupled to network devices 216 and 224, respectively. In this configuration, user device 242 serves as the source for multicast group 240 (referred to as source 242), while user device 244 requests multicast traffic for the same group (referred to as host 244). Border devices 212 and 222, equipped with more hardware resources (e.g., larger TCAMs) than non-border devices, can maintain a large number of multicast entries in their respective forwarding hardware 260 and 270. Therefore, border devices 212 and 222 can be designated as distributors for overlay networks 210 and 220, respectively, due to their enhanced capabilities.

When network device 224 receives join request 232 (such as an IGMP join) from host 244 for multicast group 240, network device 224 responds by sending notification message 234 to network devices 222 and 226 through their respective tunnels. Notification message 234 informs that network device 224 has received a request to receive multicast traffic 230 for multicast group 240. Essentially, notification message 234 indicates that host 244, accessible via network device 224, has requested to join multicast group 240. In the case where overlay networks 210 and 220 are EVPN fabrics, notification message 234 may take the form of an EVPN type-6 route update message.

Upon receiving notification message 234 from network device 224 via tunnel 252, network device 222 programs its forwarding hardware 270 with a group-specific multicast entry 272. This entry specifies that multicast traffic 230 for multicast group 240 should be forwarded to tunnel 252. As a routing peer (e.g., BGP peer) with network device 212, network device 222 facilitates traffic forwarding between overlay networks 210 and 220. Consequently, network device 222 forwards notification message 234 to network device 212 through tunnel 254. Upon receipt, network device 212 distributes notification message 234 within overlay network 210. To enable traffic forwarding to host 244, network device 212 programs a group-specific multicast entry 262 in its forwarding hardware 260, indicating that multicast traffic 230 for multicast group 240 should be directed to tunnel 254.

Before receiving any notification messages, non-distributor network devices 214, 216, and 218 in overlay network 210 are preconfigured with a generic multicast entry directing traffic to network device 122. This entry specifies that multicast traffic for any group should be forwarded to network device 122. Similarly, non-distributor network devices 224 and 226 in overlay network 220 are preprogrammed with a generic multicast entry pointing to network device 222, indicating that all multicast traffic should be directed to this device. As a result, when notification message 234 is received, these non-distributor network devices in both overlay networks 210 and 220 discard the message rather than programming their forwarding hardware, relying instead on their preprogrammed generic entries for forwarding multicast traffic.

When network device 216 receives multicast traffic 230 from source 242,network device 216 forwards this traffic to network device 212 via tunnel 256 based on the generic multicast entry. This forwarding process involves encapsulating each packet of multicast traffic 230 with an encapsulation header associated with tunnel 256 before transmission to network device 212. Upon receiving encapsulated multicast traffic 230, network device 212 decapsulates the encapsulation header, extracts multicast traffic 230, and then re-encapsulates it with another encapsulation header for tunnel 254. Network device 212 then forwards multicast traffic 230 through tunnel 254, as specified by entry 262 in its forwarding hardware 260.

Network device 222 receives multicast traffic 230 via tunnel 254, then decapsulates the encapsulation header to extract the traffic. Network device 222 subsequently re-encapsulates multicast traffic 230 with a header for tunnel 252 and forwards it through this tunnel, as specified by entry 272 in its forwarding hardware 270. Upon receiving the traffic over tunnel 252, network device 224 decapsulates the encapsulation header, retrieves multicast traffic 230, and directs it to host 244. This process demonstrates how efficiently programmed multicast entries in border devices (network devices 212 and 222) facilitate the forwarding of multicast traffic 230 when source 242 and host 244 of multicast group 240 are coupled to different overlay networks. This approach ensures seamless and efficient multicast traffic distribution across disparate overlay networks.

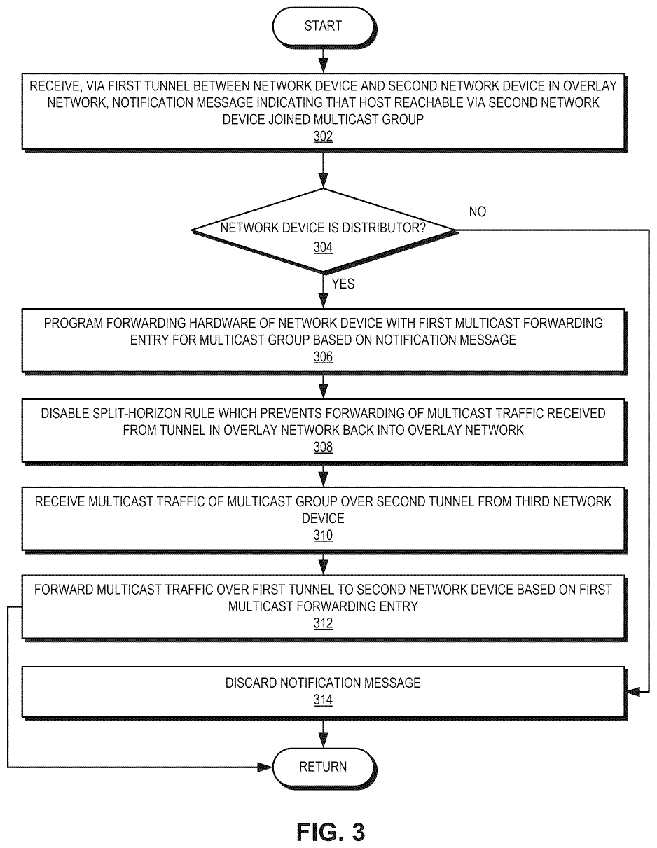

FIG. 3 presents a flowchart illustrating an example of a process of a network device forwarding multicast traffic in an overlay network, in accordance with an aspect of the present application. During operation, the network device can receive, via a first tunnel between the network device and a second network device in the overlay network, a notification message indicating that a host reachable via the second network device joined a multicast group (operation 302). The notification process is triggered when the second network device receives a client join request (such as an IGMP join) for the multicast group from the host. In response, the second network device generates the notification message indicating that a host reachable via the second network device has joined the multicast group. Subsequently, the second network device disseminates the notification message to other network devices, such as the network device that performs operation 302, in the overlay network. Upon receiving this notification message from the second network device, the network device can determine how to proceed with the pertinent information about the host and the multicast group specified in the notification message.

Accordingly, the network device can determine whether the network device is the distributor of multicast traffic in the overlay network (operation 304). The decision to program a multicast entry based on the notification message depends on whether the network device is designated as the distributor. This determination is crucial as it dictates the network device's response to the incoming information. If identified as the distributor, the network device assumes the responsibility of propagating multicast traffic across the overlay network. Accordingly, if the network device is the distributor, the network device can program the forwarding hardware of the network device with a first multicast forwarding entry for the multicast group based on the notification message (operation 306). For example, the network device can program the first multicast forwarding entry in the TCAM of the network device. Here, the first multicast forwarding entry specifies that the multicast traffic of the multicast traffic is to be forwarded through the first tunnel to the second network device.

Typically, the split-horizon rule can prevent the network device from forwarding the multicast traffic received from a tunnel in the overlay network back into the overlay network. However, the distributor is responsible for distributing the multicast traffic of the multicast group in the overlay network. To allow the network device to distribute multicast traffic received from a tunnel in the overlay network, the network device can disable the split-horizon rule (operation 308). When the source of the multicast group starts sending the multicast traffic, a third network device coupled to the source can receive the multicast traffic and forward it over a second tunnel between the network device and the third network device. Therefore, the network device can receive the multicast traffic of the multicast group over the second tunnel from the third network device (operation 310).

Since the split-horizon rule is disabled, the network device can forward the multicast traffic over the first tunnel to the second network device based on the first multicast forwarding entry (operation 312). The network device can look up the destination address of the multicast traffic in the forwarding hardware and determine that the multicast traffic is to be forwarded over the first tunnel. If the network device is not the distributor, the network device relies on a preprogrammed generic multicast entry pointing to the distributor for forwarding multicast traffic. Therefore, the network device can discard the notification message (operation 314). In the scenario depicted in FIG. 1, network device 112 serves as the distributor for overlay network 110. Upon receiving notification message 134 from network device 118, network device 112 responds by programming multicast forwarding entry 162 in its forwarding hardware 160. When multicast traffic 130 arrives via tunnel 124, network device 112 utilizes this programmed entry to forward the traffic through tunnel 122. In contrast, when network device 114, which is not designated as a distributor, receives notification message 134 from network device 118, network device 114 discards the message, as it is not responsible for multicast traffic distribution.

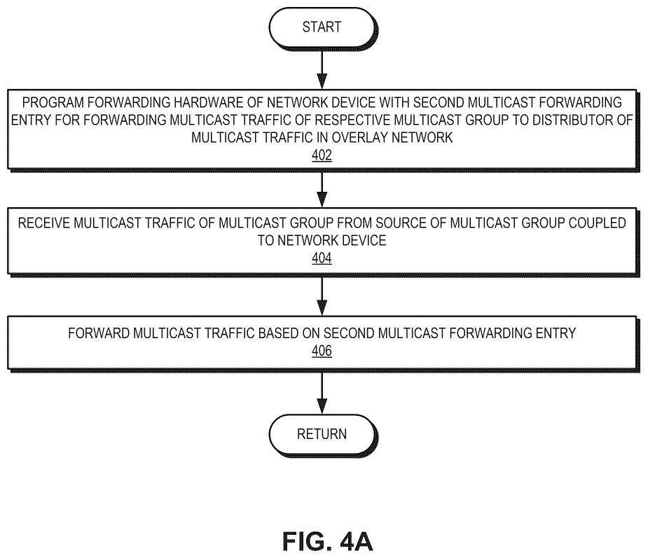

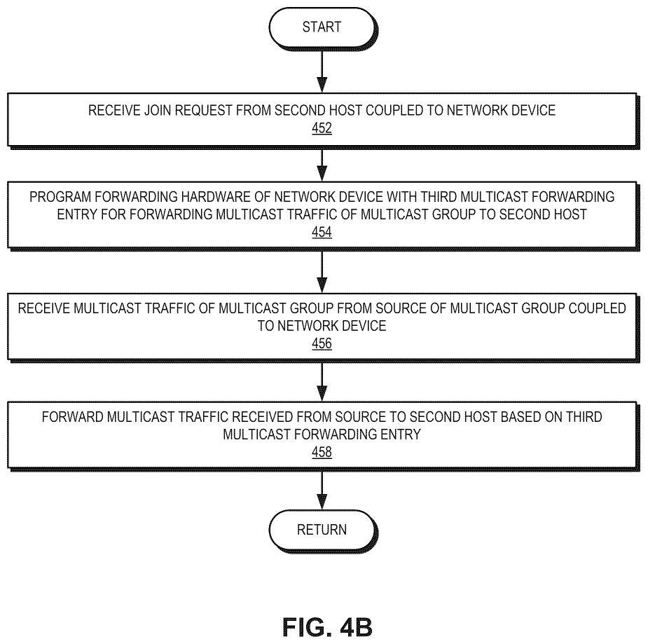

FIG. 4A presents a flowchart illustrating an example of a process of a network device forwarding multicast traffic received from a source to the multicast distributor in an overlay network, in accordance with an aspect of the present application. During operation, the network device can program the forwarding hardware of the network device with a second multicast forwarding entry for forwarding multicast traffic of a respective multicast group to the distributor of multicast traffic in the overlay network (operation 402). Here, the second multicast forwarding entry serves as a generic multicast entry. This entry specifies that any multicast traffic received by the network device from a port (as opposed to a tunnel) should be forwarded to the distributor. The network device can then receive multicast traffic of a multicast group from the source of the multicast group coupled to the network device (operation 404). In this configuration, the source can be coupled to a port of the network device via one or more links.

The network device can then forward the multicast traffic based on the second multicast forwarding entry (operation 406). When the network device receives multicast traffic, it performs a lookup of the destination address in its forwarding hardware, typically in the TCAM. This lookup identifies the second multicast forwarding entry, which directs the device to forward the traffic to the distributor. The network device then forwards the multicast traffic accordingly. In the specific scenario illustrated in FIG. 1, network device 116 has programmed a generic multicast entry 172 into its forwarding hardware 170. When network device 116 receives multicast traffic 130 from source 142, based on entry 172, network device 116 forwards this multicast traffic 130 to network device 112 (the distributor) via tunnel 124.

FIG. 4B presents a flowchart illustrating an example of a process of a network device forwarding multicast traffic received from a source to a host coupled to the network device, in accordance with an aspect of the present application. During operation, the network device can receive a join request from a second host coupled to the network device (operation 452). Here, the network device performing the process described in FIG. 4B can correspond to the network device performing the process described in FIG. 4A. When the second host initiates a client join request (such as an IGMP join) for the multicast group, the second host directs this request to the network device. Given that the network device is directly coupled to the source of the multicast group, it can enhance traffic flow by locally forwarding the multicast traffic from the source to the second host. This direct forwarding eliminates the need to send the traffic over a tunnel, reducing network overhead and latency. Accordingly, the network device can program the forwarding hardware of the network device with a third multicast forwarding entry for forwarding the multicast traffic of the multicast group to the second host (operation 454).

When the source of the multicast group initiates the multicast traffic, the network device can then receive the multicast traffic of the multicast group from the source of the multicast group coupled to the network device (operation 456). The network device can then forward the multicast traffic based on the third multicast forwarding entry (operation 458). When the network device receives multicast traffic, the network device performs a lookup of the destination address in its forwarding hardware. This lookup identifies the third multicast forwarding entry, which specifies that the traffic should be directed to the second host. Based on the third multicast forwarding entry, the network device forwards the multicast traffic directly to the second host. In the specific scenario in FIG. 1, network device 116 has programmed multicast entry 174 into its forwarding hardware 170. When network device 116 receives multicast traffic 130 from source 142, based on entry 174, network device 116 forwards this multicast traffic 130 directly to host 146.

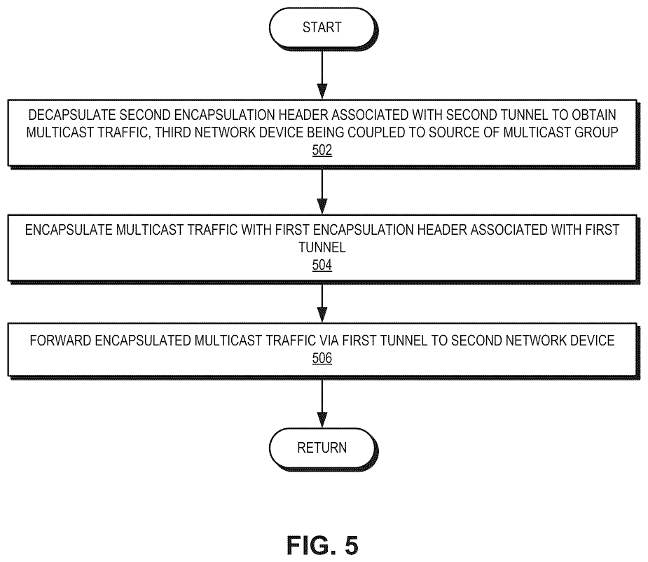

FIG. 5 presents a flowchart illustrating an example of a process of a network device receiving and forwarding multicast traffic in an overlay network based on respective encapsulation headers, in accordance with an aspect of the present application. During operation, the network device can decapsulate a second encapsulation header associated with the second tunnel to obtain the multicast traffic (operation 502). In this scenario, the network device can function as the distributor for multicast traffic. Here, the network device performing the process described in FIG. 5 can correspond to the network device performing the process described in FIG. 3. As such, it receives multicast traffic over the second tunnel from the source network device coupled to the source. The multicast traffic arrives encapsulated with the second encapsulation header associated with the second tunnel. The network device decapsulates the second encapsulation header, thereby extracting the original multicast traffic. By decapsulating the second encapsulation header, the network device can access the multicast traffic and determine further distribution based on its role as the multicast distributor.

Subsequently, the network device is to forward the multicast traffic to a respective requesting network device via a corresponding tunnel. Hence, the network device can encapsulate the multicast traffic with a first encapsulation header associated with the first tunnel (operation 504). The first tunnel is between the network device and the second network device, which serves as the requesting network device. Therefore, the packets obtained by decapsulating the second encapsulation header in operation 502 can be re-encapsulated with the first encapsulation header associated with the first tunnel in operation 504. The network device can then forward the encapsulated multicast traffic via the first tunnel to the second network device (operation 506). In the scenario in FIG. 1, network device 112 decapsulates the encapsulation header associated with tunnel 124, which allows it to extract multicast traffic 130. Following this, network device 112 proceeds to re-encapsulate multicast traffic 130 with a new encapsulation header associated with tunnel 122. This newly encapsulated multicast traffic 130 is then transmitted to network device 118 via tunnel 122.

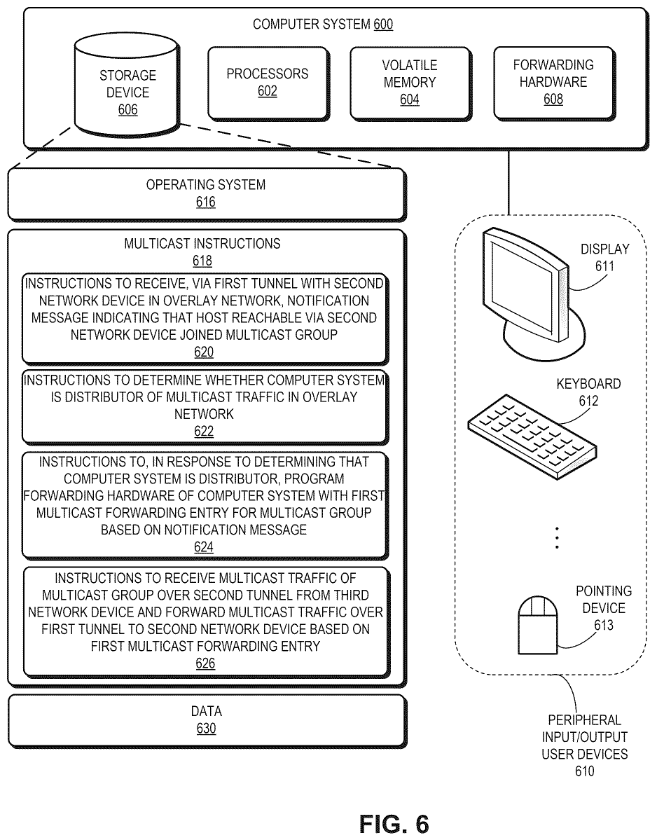

FIG. 6 illustrates an example of a computing system programming multicast forwarding entries and forwarding multicast traffic in an overlay network, in accordance with an aspect of the present application. Computer system 600 includes one or more processors 602, a memory 604, a storage device 606, and forwarding hardware 608. Processors 602 can include one or more processing resources, such as processor cores, GPUs, and TPUs. Memory 604 can include a volatile memory (e.g., random access memory (RAM)) that serves as a managed memory and can be used to store one or more memory pools. Furthermore, computer system 600 can be coupled to peripheral I/O user devices 610 (e.g., a display device 611, a keyboard 612, and a pointing device 613). Forwarding hardware 608 can include a TCAM. Storage device 606 includes a non-transitory computer-readable storage medium and stores an operating system 616, multicast instructions 618, and data 630. Computer system 600 may include fewer or more entities or instructions than those shown in FIG. 6. Computer system 600 can correspond to network device 112 or 116 of FIG. 1, or network device 212 of FIG. 2.

Multicast instructions 618 can include instructions, which when executed by computer system 600, can cause computer system 600 to perform methods and/or processes described in this disclosure. Multicast instructions 618 can be executed on at least one of processors 602, forwarding hardware 608, or a combination thereof. Computer system 600 can be a network device, such as network device 122 in FIG. 1 and network device 222 in FIG. 2. Specifically, multicast instructions 618 may include instructions 620 to receive, via a first tunnel between computer system 600 and a second network device in an overlay network, a notification message indicating that a host reachable via the second network device joined a multicast group. When the second network device receives a client join request (e.g., an IGMP join) from the host, the second network device can send the notification message to a respective other network device in the overlay network. In the example in FIG. 1, network device 112 can receive notification message 134 from network device 118 over tunnel 122.

Multicast instructions 618 may also include instructions 622 to determine whether computer system 600 is the distributor of multicast traffic in the overlay network. In the example in FIG. 1, network device 112 can determine whether it is the distributor of multicast traffic in overlay network 110. Furthermore, multicast instructions 618 may also include instructions 624 to, in response to determining that computer system 600 is the distributor, program the forwarding hardware 608 with a first multicast forwarding entry for the multicast group based on the notification message. In the example in FIG. 1, network device 112 can determine that it is the distributor in overlay network 110. Accordingly, network device 112 can program a multicast forwarding entry 162 in forwarding hardware 160 of network device 112.

Multicast instructions 618 may include instructions 626 to receive the multicast traffic of the multicast group over a second tunnel from the third network device and forward the multicast traffic over the first tunnel to the second network device based on the first multicast forwarding entry. Since the distributor is responsible for distributing the multicast traffic of the multicast group in the overlay network, computer system 600 can disable the split-horizon rule for forwarding multicast traffic. Therefore, computer system 600 can forward the multicast traffic received from the second tunnel to the first tunnel. In the example in FIG. 1, upon receiving multicast traffic 130 via tunnel 124, network device 112 can forward multicast traffic 130 over tunnel 122 based on entry 162 in forwarding hardware 160.

Data 630 can include any data that is required as input, or that is generated as output by the methods, operations, communications, and/or processes described in this disclosure. Specifically, data 630 can include a group-specific multicast forwarding entry (e.g., entry 162 in FIG. 1 and entry 272 in FIG. 2), a generic multicast forwarding entry (e.g., entry 172 in FIG. 1), and a multicast forwarding entry for forwarding locally received multicast traffic (e.g., entry 174 in FIG. 1). Data 630 can also include a group-specific multicast forwarding entry for forwarding multicast traffic to another overlay network (e.g., entry 262 in FIG. 1).

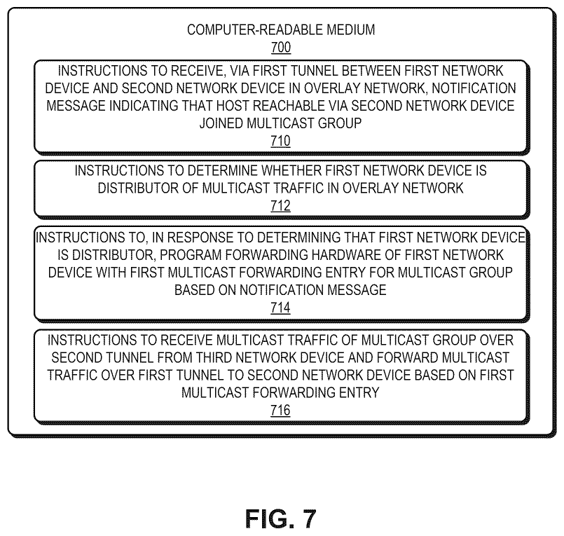

Computer system 600 and multicast instructions 618 may include more instructions than those shown in FIG. 6. For example, multicast instructions 618 can also store instructions for receiving multicast traffic 130 from host 142 of FIG. 1; disabling the split-horizon rule for network device 112 of FIG. 1; programming a multicast forwarding entry 174 for forwarding multicast traffic 130 to a locally coupled host 146 of FIG. 1; discarding notification message 134 at network device 114 of FIG. 1; encapsulating and decapsulating encapsulation headers associated with tunnels 122 and 124, respectively, of FIG. 1; receiving a notification message 234 from overlay network 220 at network device 212 of overlay network 210 of FIG. 2; programming a multicast forwarding entry 262 for forwarding multicast traffic 230 from overlay network 210 to overlay network 220 of FIG. 2; forwarding multicast traffic 230 to overlay network 220 of FIG. 2; the operations depicted in the flowcharts of FIGS. 3, 4, and 5; and the instructions of non-transitory CRM 700 in FIG. 7.

FIG. 7 illustrates an example of a CRM facilitating the programming of multicast forwarding entries and forwarding of multicast traffic in an overlay network, in accordance with an aspect of the present application. CRM 700 can include one or more non-transitory computer-readable mediums or devices storing instructions that, when executed by a computer or processor, cause the computer or processor to perform a method. Therefore, the instructions in CRM 700 can be stored in one or more non-transitory computer-readable mediums or devices. CRM 700 can receive, via a first tunnel between a first network device and a second network device in an overlay network, a notification message indicating that a host reachable via the second network device joined a multicast group. In the example in FIG. 1, network device 112 can receive notification message 134 from network device 118 over tunnel 122.

CRM 700 can also include instructions 712 to determine whether the first network device is the distributor of multicast traffic in the overlay network. In the example in FIG. 1, network device 112 can determine whether it is the distributor of multicast traffic in overlay network 110. CRM 700 can include instructions 714 to, in response to determining that the first network device is the distributor, program the forwarding hardware 608 with a first multicast forwarding entry for the multicast group based on the notification message. In the example in FIG. 1, network device 112 can determine that it is the distributor in overlay network 110. Accordingly, network device 112 can program a multicast forwarding entry 162 in forwarding hardware 160 of network device 112. Furthermore, CRM 700 can include instructions 716 to receive the multicast traffic of the multicast group over a second tunnel from the third network device and forward the multicast traffic over the first tunnel to the second network device based on the first multicast forwarding entry. In the example in FIG. 1, upon receiving multicast traffic 130 via tunnel 124, network device 112 can forward multicast traffic 130 over tunnel 122 based on entry 162 in forwarding hardware 160.

CRM 700 may include more instructions than those shown in FIG. 7. For example, CRM 700 can also store instructions for receiving multicast traffic 130 from host 142 of FIG. 1; disabling the split-horizon rule for network device 112 of FIG. 1; programming a multicast forwarding entry 174 for forwarding multicast traffic 130 to a locally coupled host 146 of FIG. 1; discarding notification message 134 at network device 114 of FIG. 1; encapsulating and decapsulating encapsulation headers associated with tunnels 122 and 124, respectively, of FIG. 1; receiving a notification message 234 from overlay network 220 at network device 212 of overlay network 210 of FIG. 2; programming a multicast forwarding entry 262 for forwarding multicast traffic 230 from overlay network 210 to overlay network 220 of FIG. 2; forwarding multicast traffic 230 to overlay network 220 of FIG. 2; the operations depicted in the flowcharts of FIGS. 3, 4, and 5; and the instructions of computer system 600 in FIG. 6.

The description herein is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown, but is to be accorded the widest scope consistent with the claims.

One aspect of the present technology can provide a first network device in a first overlay network. During operation, the first network device can receive a notification message indicating that a host reachable via a second network device joined a multicast group. The notification message can be received via a first tunnel between the first and second network devices in the first overlay network. The first network device can determine whether the first network device is a distributor of multicast traffic in the first overlay network. In response to determining that the first network device is the distributor, the first network device can program the forwarding hardware of the first network device with a first multicast forwarding entry for the multicast group based on the notification message. The first network device can then receive the multicast traffic of the multicast group over a second tunnel from a third network device and forward the multicast traffic over the first tunnel to the second network device based on the first multicast forwarding entry.

In a variation on this aspect, the second network device can be in a second overlay network. The first network device can include, in an encapsulation header associated with the first tunnel, an indicator indicating that the first network device is in the first overlay network.

In a variation on this aspect, in response to determining that the first network device is not the distributor, the first network device can discard the notification message and program the forwarding hardware of the first network device with a second multicast forwarding entry for forwarding multicast traffic of a respective multicast group to the distributor of multicast traffic in the first overlay network.

In a further variation, the first network device can be coupled to a source of the multicast group. The first network device can receive the multicast traffic of the multicast group from the source and forward the multicast traffic based on the second multicast forwarding entry.

In a further variation, the first network device can receive a join request from a second host coupled to the first network device. The first network device can then program the forwarding hardware of the first network device with a third multicast forwarding entry for forwarding the multicast traffic of the multicast group to the second host. Subsequently, the first network device can forward the multicast traffic received from the source to the second host based on the third multicast forwarding entry.

In a variation on this aspect, to forward the multicast traffic over the first tunnel, the first network device can encapsulate the multicast traffic with a first encapsulation header associated with the first tunnel.

In a further variation, the first network device can decapsulate a second encapsulation header associated with the second tunnel to obtain the multicast traffic. Here, the third network device is coupled to a source of the multicast group.

In a variation on this aspect, the third network device can be a border device of a second overlay network coupled to a source of the multicast group.

In a variation on this aspect, the notification message can be an Ethernet virtual private network (EVPN) type-6 message.

In a variation on this aspect, if the first network device is the distributor, the first network device can disable a split-horizon rule for the first network device. The split-horizon rule can prevent forwarding of the multicast traffic received from a tunnel in the first overlay network back into the first overlay network.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware logic blocks or apparatus. These logic blocks or apparatus may include, but are not limited to, an application-specific integrated circuit (ASIC) chip, a field-programmable gate array (FPGA), a dedicated or shared processor that executes a particular software logic block or a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method, comprising:
receiving, by a first network device via a first tunnel in a first overlay network, a notification message indicating that a host reachable via a second network device joined a multicast group, wherein the first tunnel is between the first and second network devices;
determining whether the first network device is a distributor of multicast traffic in the first overlay network; and
in response to determining that the first network device is the distributor:
programming forwarding hardware of the first network device with a first multicast forwarding entry for the multicast group based on the notification message;
receiving, by the first network device, multicast traffic of the multicast group over a second tunnel from a third network device; and
forwarding the multicast traffic over the first tunnel to the second network device based on the first multicast forwarding entry.

2. The method of claim 1, wherein the second network device is in a second overlay network; and
wherein the method further comprises including, in an encapsulation header associated with the first tunnel, an indicator indicating that the first network device is in the first overlay network.

3. The method of claim 1, wherein, in response to determining that the first network device is not the distributor, the method further comprises:
discarding the notification message; and
programming the forwarding hardware of the first network device with a second multicast forwarding entry for forwarding multicast traffic of a respective multicast group to the distributor of multicast traffic in the first overlay network.

4. The method of claim 3, wherein the first network device is coupled to a source of the multicast group; and
wherein the method further comprises:
receiving the multicast traffic of the multicast group from the source; and
forwarding the multicast traffic based on the second multicast forwarding entry.

5. The method of claim 4, further comprising:
receiving a join request from a second host coupled to the first network device;
programming the forwarding hardware of the first network device with a third multicast forwarding entry for forwarding the multicast traffic of the multicast group to the second host; and
forwarding the multicast traffic received from the source to the second host based on the third multicast forwarding entry.

6. The method of claim 1, wherein forwarding the multicast traffic over the first tunnel comprises encapsulating the multicast traffic with a first encapsulation header associated with the first tunnel.

7. The method of claim 6, further comprising decapsulating a second encapsulation header associated with the second tunnel to obtain the multicast traffic, wherein the third network device is coupled to a source of the multicast group.

8. The method of claim 1, wherein the third network device is a border device of a second overlay network coupled to a source of the multicast group.

9. The method of claim 1, wherein the notification message is an Ethernet virtual private network (EVPN) type-6 message.

10. The method of claim 1, further comprising disabling, in response to the first network device being the distributor, a split-horizon rule for the first network device, wherein the split-horizon rule prevents forwarding of multicast traffic received from a tunnel in the first overlay network back into the first overlay network.

11. A non-transitory computer-readable storage medium storing instructions to:
receive, by a first network device via a first tunnel in a first overlay network, a notification message indicating that a host reachable via a second network device joined a multicast group, wherein the first tunnel is between the first and second network devices;
determine whether the first network device is a distributor of multicast traffic in the first overlay network; and
in response to determining that the first network device is the distributor:
program forwarding hardware of the first network device with a first multicast forwarding entry for the multicast group based on the notification message;
receive, by the first network device, multicast traffic of the multicast group over a second tunnel from a third network device; and
forward the multicast traffic over the first tunnel to the second network device based on the first multicast forwarding entry.

12. The non-transitory computer-readable storage medium of claim 11, wherein the second network device is in a second overlay network;
wherein the instructions are further to include, in an encapsulation header associated with the first tunnel, an indicator indicating that the first network device is in the first overlay network.

13. The non-transitory computer-readable storage medium of claim 11, wherein, in response to determining that the first network device is not the distributor, wherein the instructions are further to:
discard the notification message; and
program the forwarding hardware of the first network device with a second multicast forwarding entry for forwarding multicast traffic of a respective multicast group to the distributor of multicast traffic in the first overlay network.

14. The non-transitory computer-readable storage medium of claim 13, wherein the first network device is coupled to a source of the multicast group; and
wherein the instructions are further to:
receive the multicast traffic of the multicast group from the source; and
forward the multicast traffic based on the second multicast forwarding entry.

15. The non-transitory computer-readable storage medium of claim 14, wherein the instructions are further to:
receive a join request from a second host coupled to the first network device;
program the forwarding hardware of the first network device with a third multicast forwarding entry for forwarding the multicast traffic of the multicast group to the second host; and
forward the multicast traffic received from the source to the second host based on the third multicast forwarding entry.

16. The non-transitory computer-readable storage medium of claim 11, wherein forwarding the multicast traffic over the first tunnel comprises encapsulating the multicast traffic with a first encapsulation header associated with the first tunnel;
wherein the instructions are further to decapsulate a second encapsulation header associated with the second tunnel to obtain the multicast traffic, wherein the third network device is coupled to a source of the multicast group.

17. The non-transitory computer-readable storage medium of claim 11, wherein the third network device is a border device of a second overlay network coupled to a source of the multicast group.

18. The non-transitory computer-readable storage medium of claim 11, wherein the notification message is an Ethernet virtual private network (EVPN) type-6 message.

19. The non-transitory computer-readable storage medium of claim 11, wherein the instructions are further to disable, in response to the first network device being the distributor, a split-horizon rule for the first network device, wherein the split-horizon rule prevents forwarding of multicast traffic received from a tunnel in the first overlay network back into the first overlay network.

20. A computer system, comprising:
at least one processing resource;
forwarding hardware; and
a non-transitory computer-readable storage medium storing instructions that when executed by the processing resource cause the computer system to:
receive, via a first tunnel in a first overlay network, a notification message indicating that a host reachable via a first network device joined a multicast group, wherein the first tunnel is between the computer system and the first network device;
determine whether the computer system is a distributor of multicast traffic in the first overlay network; and
in response to determining that the computer system is the distributor:
program the forwarding hardware with a first multicast forwarding entry for the multicast group based on the notification message;
receive multicast traffic of the multicast group over a second tunnel from a second network device; and
forward the multicast traffic over the first tunnel to the first network device based on the first multicast forwarding entry.
